(19) United States
(12) Patent Application Publication
(10) Pub. No.: US 2003/0021009 A1
(43) Pub. Date: Jan. 30, 2003

(54) Wide dynamic range EDFA

(76) Inventors: Stuart MacCormack, Mountain View, CA (US); Steven Sanders, Belmont, CA (US)

Correspondence Address: JDS UNIPHASE CORPORATION, INTELLECTUAL PROPERTY DEPARTMENT, 3000 MERIVALE ROAD, OTTAWA, ON, K2G 6N7, CA

(21) Appl. No.: 09/912,998

(22) Filed: Jul. 25, 2001

(51) Int. Cl. H01S 3/00

(52) U.S. Cl. 359/337

(57) ABSTRACT

An erbium doped fiber amplifier that includes two separate variable optical attenuators that provide signal attenuation to eliminate spectrum tilt of the amplified optical signal. The erbium doped fiber amplifier includes a first pre-amplifier stage, a second pre-amplifier stage and a power amplifier stage. A primary variable optical attenuator is positioned between the first pre-amplifier stage and the second pre-amplifier stage, and a secondary variable optical attenuator is positioned between the second pre-amplifier stage and the power amplifier stage. By providing two separate variable optical attenuators at two different locations, the internal loss variation in the erbium doped fiber amplifier is averaged to provide an improved amplifier design and noise figure performance.

### BACKGROUND OF THE INVENTION

1. Field of the Invention

This invention relates generally to an erbium doped fiber amplifier employing a variable optical attenuator and, more particularly, to an erbium doped fiber amplifier employing a primary variable optical attenuator and a secondary variable optical attenuator at different locations along the erbium doped fiber in the amplifier.

2. Discussion of the Related Art

Optical communication systems employ optical fibers to transmit optical signals carrying information over great distances. An optical fiber is an optical waveguide including a core having one index of refraction surrounded by a cladding having another, lower, index of refraction so that light signals propagating down the core at a certain angle of incidence are trapped therein. Typical optical fibers are made of a high purity silica including certain dopant atoms that control the index of refraction of the core and cladding.

The optical signals are separated into optical packets to distinguish groups of information. Different techniques are known in the art to identify the optical packets transmitted down an optical fiber. These techniques include time-division multiplexing (TDM) and wavelength-division multiplexing (WDM). In TDM, different slots of time are allocated for the various packets of information. In WDM, different wavelengths of light are allocated for different data channels carrying the optical packets. More particularly, sub-bands within a certain bandwidth of light are separated by predetermined wavelengths to identify the various data channels.

When optical signals are transmitted over great distances through optical fibers, attenuation within the fibers reduces the optical signal strength. Therefore, detection of the optical signals over background noise becomes more difficult at the receiver. In order to overcome this problem, optical amplifiers are positioned at predetermined intervals along the fiber, for example, every 80-100 km, to provide optical signal gain. Various types of amplifiers are known that provide an amplified replica of the optical signal, and provide amplification for the various modulation schemes and bit-rates that are used.

A popular optical amplifier for this purpose is an erbium doped fiber amplifier (EDFA) that provides optical amplification over the desired transmission wavelengths. EDFAs are common because erbium atoms provide light amplification over a relatively broad wavelength range, for example, 1525-1610 nm. The erbium doped fiber within the EDFA is pumped by a pump laser at a certain excitation frequency, such as 980 nm or 1480 nm. The pump light is absorbed by the erbium atoms that cause electrons in the atoms to be elevated to higher states. When a photon in the optical signal being transmitted hits an excited erbium atom, a photon of the same wavelength and at the same phase is emitted from an elevated electron, which causes the electron to decay to a lower state to again be excited to a higher state by the pump photons. The optical signal is amplified by the generation of additional photons in this manner. If the excited atoms spontaneously emit a photon, where the photon is emitted without being activated by an incoming photon, typically the spontaneous photon is not in phase with the optical signal being transmitted. Spontaneously emitted photons add noise to the amplified signal, where this reduction in the signal-to-noise ratio is typically referred to as the amplifier noise figure.

Optical amplifiers of the type being discussed herein suffer from certain disadvantages. In a WDM system, the gain provided by the EDFA is not the same for all frequency channels because the gain spectrum of the amplifier is non-uniform. As the optical signals on the various channels propagate through successive amplifiers, the non-uniformity of the wavelength amplification is further exacerbated so that more amplification is provided for those optical wavelengths having the larger amplitudes. The maximum transmission distance in an optical WDM transmission link is limited to the distance when the signal-to-noise degradation for any individual wavelength channel reaches some critical value. To maximize the transmission capacity of a WDM link it is desirable for all optical channels to experience identical gain and noise accumulation along the transmission link. Therefore, gain flattening filters are employed in combination with optical amplifiers that provide attenuation that is an inverse of the gain profile of the amplifier to generate a flat gain spectrum.

In practical applications, the EDFA must operate with a relative flat gain spectrum over a wide dynamic range of input powers. Variations in input power may arise from differences in the length of the fiber transmission link, variations in fiber absorption or differences in launched powers. Most conventional transmission systems require that the EDFA maintain a flat gain over a 0-10 dB variation in input power.

For an EDFA operating at a fixed output power, as the magnitude of the input optical signal being amplified by the EDFA changes, a tilt is formed in the amplified signal where either the longer wavelength or shorter wavelength signals become more amplified. When the input signal power decreases, a negative tilt occurs where the shorter wavelengths of the optical signal receive more gain than the longer wavelengths. When the input signal power increases, a positive tilt occurs where the longer wavelengths of the optical signal receive more gain than the shorter wavelengths.

The usual approach for compensating for gain tilt to maintain a flat gain spectrum is by incorporating a variable optical attenuator (VOA) in the amplifier. As the input signal power is increased, the VOA is adjusted to increase the internal loss in the amplifier, thereby maintaining a constant end-to-end gain in the amplifier. Since the gain tilt of the amplifier depends on the net amplifier gain, this results in the gain flatness being maintained over the full range of inputs. However, increasing the internal loss within the amplifier will eventually lead to a significant deterioration in the amplifier noise figure. Typically, the larger the dynamic range of the input power, the higher the resulting noise figure for the amplifier.

This problem becomes more serious in an EDFA that must operate with a Raman pre-amplifier in addition to operating as a stand alone EDFA. In this case, not only does the EDFA have to maintain a flat gain spectrum over the variation in input power from conventional reasons, but also has to incorporate an additional 10 dB variation in the input power that may result from the addition of the Raman pre-amplifier. Thus, VOA losses of up to 20 dB may be required to maintain flat operation for an amplifier employing a Raman pre-amplifier.

Typically, an EDFA design employing a single loss of 20 dB will exhibit a very poor noise figure. This is because the signal power after the loss will typically fall below the level of the input, thereby setting a new shot-noise floor within the amplifier and resulting in an effective negative gain in the early stages of the amplifier.

### SUMMARY OF THE INVENTION

In accordance with the teachings of the present invention, an erbium doped fiber amplifier is disclosed that includes two separate variable optical attenuators that provide signal attenuation to eliminate spectrum tilt of the amplified optical signal over relatively large input powers. In one embodiment, the EDFA is a three stage amplifier including a first pre-amplifier stage, a second pre-amplifier stage and a power amplifier stage. A primary VOA is positioned between the first pre-amplifier stage and the second pre-amplifier stage, and a secondary VOA is positioned between the second pre-amplifier stage and the power amplifier stage. By providing two separate VOAs at two different locations, the internal loss variation in the EDFA is distributed to provide an improved amplifier design and noise figure performance.

Additional objects, advantages, and features of the present invention will become apparent from the following description and appended claims, taken in conjunction with the accompanying drawings.

### BRIEF DESCRIPTION OF THE DRAWING

FIG. 1 is a block diagram of an erbium doped fiber amplifier including two variable optical attenuators, according to an embodiment of the present invention; and

FIGS. 2(a) and 2(b) are graphs with signal gain in dB on the vertical axis and length of the amplifiers on the horizontal axis showing the gain profile of a known EDFA having a single VOA, and an EDFA having a primary VOA and a secondary VOA, according to the invention, respectively.

### DETAILED DESCRIPTION OF THE EMBODIMENTS

The following discussion of the embodiments of this invention directed to an erbium doped fiber amplifier employing two variable optical attenuators is merely exemplary in nature, and is in no way intended to limit the invention, or its application or uses.

According to the invention, an EDFA is provided that includes a second VOA that allows the high internal losses in the EDFA to be distributed between two separate locations, rather than at a single location as in the prior art amplifiers. This design has the advantage of obtain a higher minimum signal power within the amplifier, resulting in a significantly improved noise figure for the amplifier. In one embodiment, the primary VOA is positioned proximate to a dispersion compensating module (DCM) because the DCM loss is typically lower for shorter transmission spans which require high VOA loss due to a high input signal power. This design averages out the extremes of the internal loss variation of the EDFA, and allows an improved amplifier design and noise figure performance.

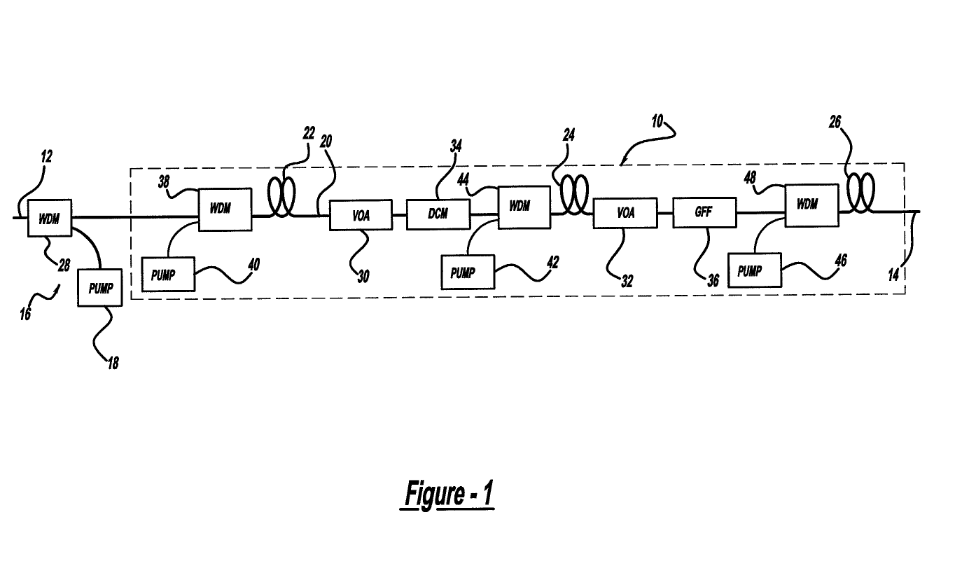

FIG. 1 is a schematic block diagram of an EDFA 10, according to an embodiment of the present invention. An input transmission link optical fiber 12 is coupled to an input end of the EDFA 10, and an output transmission link optical fiber 14 is coupled to an output end of the EDFA 10, as shown. The optical fibers 12 and 14 include a core and an outer cladding layer, where the optical signal being transmitted propagates through the core. The input fiber 12 and the output fiber 14 make up the transmission link and are coupled to an erbium doped fiber 20 that extends through the EDFA 10. The core and cladding layers of the fibers 12, 14 and 20 are coupled together in a manner than minimizes reflections.

As is well understood in the art, the core of the fiber 20 is doped with erbium atoms that provide light amplification at the desired wavelengths. The fiber 20 is pumped in the forward or co-propagating direction using, for example, a 980 nm or 1480 nm laser pump source 40. Light from the pump source 40 is coupled into the fiber 20 using a wavelength division multiplexer (WDM) 24 in a manner that is well understood in the art. The pump light is absorbed by the erbium atoms along the length of the fibers 16 providing high gain and high population inversion at the input end of the fiber 20. As discussed above, EDFAs are positioned along the span length of a transmission link approximately every 80-100 km to amplify the signals because of signal attenuation.

In the design depicted, a Raman amplifier 16 is provided in front of the EDFA 10. The Raman amplifier 16 is an optional amplifier that provides optical gain and a low noise figure for certain applications, as is well understood in the art. The Raman amplifier 16 includes an optical pump source 18 and a wavelength division multiplexer (WDM) positioned in the input fiber 12. The pump source 18 provides an optical pump signal at certain wavelengths that is multiplexed onto the fiber 12 in a counter-propagating direction relative to the transmission signal. The wavelength of the pump signal interacts with the glass molecules in the fiber 12 to amplify the transmission signal along a certain length of the fiber 12 in front of the EDFA 10. In an alternate embodiment, the Raman amplifier 16 can be positioned well in front of the EDFA, or in the output fiber 14 proximate the EDFA 10, where the pump signal is multiplexed onto the fiber 12 or 14 in a co-propagating direction relative to the transmission signal.

In this embodiment, the EDFA 10 is a three-stage device, but could include more amplifying stages. The EDFA 10 includes a first pre-amplifier stage 22, a second pre-amplifier stage 24 and a power amplifier stage 26. The amplifier stages 22, 24 and 26 are coils of the fiber 20, as shown. In this embodiment, the pre-amplifier stage 22 is pumped by the pump source 40. Additionally, the pre-amplifier stage 24 is pumped by a pump source 42 and a WDM 44, and the power amplifier stage 24 is pumped by a pump source 46 and a WDM 48. As is understood in the art, the pre-amplifier stages 22 and 24 each have a relatively low noise figure and high gain, and the power amplifier stage 26 has a relatively high noise figure and high efficiency. Such a design is typical in EDFAs so that the overall noise figure of the EDFA 10 is low compared to the signal gain. However, other permutations and variations of pre-amplifier stages and power amplifier stages can be combined within the scope of the present invention.

As discussed above, it is known in the art to provide a primary VOA 30 between the first pre-amplifier stage 22 and the second pre-amplifier stage 24. The operation of a VOA in an EDFA is well understood to those skilled in the art, and a suitable VOA for the purposes discussed herein would also be well known. However, certain amplifier designs may have a large potential power swing (>20 dB) of the optical signal, such as those designs including the Raman amplifier 16. In those designs, providing a single VOA that can attenuate the optical signal over the whole power swing produces a noise figure that is unacceptably high.

According to the invention, a secondary VOA 32 is provided so that the attenuation of the primary VOA 30 can be reduced, thereby achieving an improved amplifier noise figure. In this design, the secondary VOA 32 is positioned in the fiber 20 between the second pre-amplifier stage 24 and the power amplifier stage 26. By providing the secondary VOA 32 at this location, the attenuation provided by the VOA 30 can be reduced while maintaining the same total attenuation with the EDFA 10. The attenuation required to achieve the spectrally flat EDFA gain that was originally provided by the primary VOA 30 is now distributed between two locations rather than a single point. In this configuration, the signal sees a smaller attenuation at the primary VOA 30 at the exit from the first pre-amplifier stage 22. The signal is then boosted in the second pre-amplifier 24 before experiencing the remaining attenuation in the secondary VOA 32. In one non-limiting embodiment, VOAs 30 and 32 operate in the range of 0 to 15 dB.

The EDFA 10 includes other amplifier components for providing different things that affect the attenuation of the transmission signal. For example, in this design, a dispersion compensating module (DCM) 34 is provided between the first pre-amplifier stage 22 and the second pre-amplifier stage 24. As is known in the art, a DCM is used to reduce or eliminate the differences in propagation times between the various frequencies in the optical signal, so that an undistorted temporal pulse is received at the detector.

Further, a gain flattening filter (GFF) 36 is provided between the second pre-amplifier stage 24 and the power amplifier stage 26. The GFF 36 provides attenuation that is an inverse of the natural gain profile of the EDFA 10 so that the EDFA 10 generates a flat gain spectrum for all of the wavelengths being amplified. The operation of a GFF is well understood in the art. By separating the various amplification components between the first pre-amplifier stage 22 and the second pre-amplifier stage 24, and between the second pre-amplifier stage 24 and the power amplifier stage 26, the attenuation provided by these components is better dispersed across the EDFA 10.

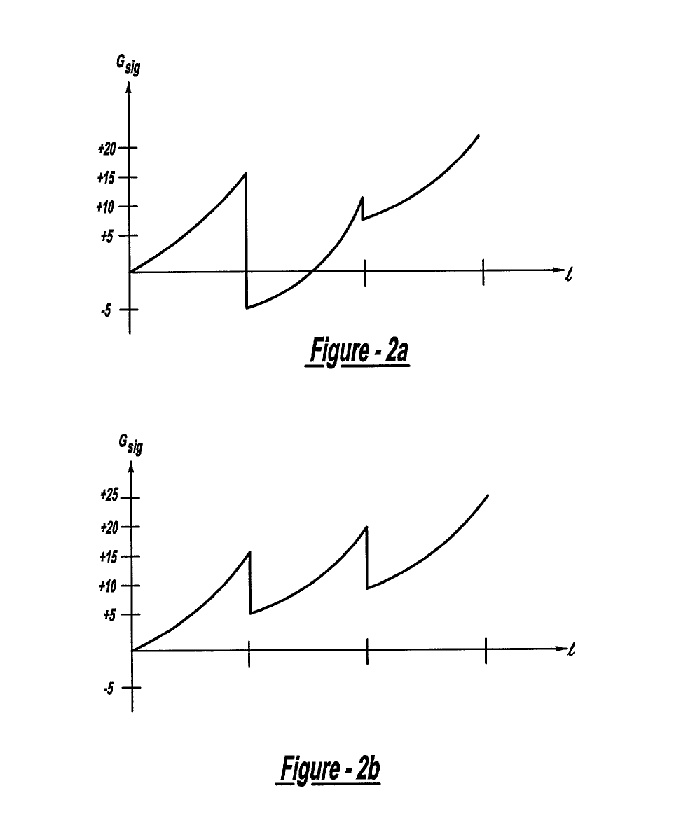

FIGS. 2(a) and 2(b) are graphs with signal gain (G_{sig}) on the vertical axis and length of the amplifier on the horizontal axis. The prior art technique of employing a single VOA is shown in FIG. 2(a), and the technique of the invention of employing the primary VOA 30 and the secondary VOA 32 is shown in FIG. 2(b) to depict the advantages of the invention. As is apparent from the prior art technique, signal gain is provided by the first amplifier stage, and is then attenuated by the primary VOA so that the signal gain actually drops below 0. In this depiction, the first stage provides about +15 dB of signal gain, and the VOA reduces the gain about 20 dB. Because the signal power after the loss provided by the VOA falls below the level of the input to the amplifier, a new shot-noise floor is set in the amplifier, resulting in an effective negative gain in the early stages of the amplifier. The next sections of the graph show the gain provided by the second amplifying stage, a small attenuation by other components, such as DCMs or GFFs, between the second and third amplifying stages, and the gain of the third amplifying stage so that signal is ultimately amplified by 20 dB. Because the VOA drops the signal gain below zero, the resulting EDFA exhibits a very poor noise figure, significantly limiting its performance in an optical transmission link.

FIG. 2(b) shows that the first pre-amplifier stage 22 provides about 15 dB of signal gain, and then the primary VOA 30 reduces the signal gain by 10 dB. As is apparent, the signal gain does not drop below zero. The second pre-amplifier stage 24 again amplifies the signal by about 15 dB, and the secondary VOA 32 attenuates the signal by about 10 dB. The power amplifier stage 26 again amplifies the signal by about 15 dB to get a total of 25 dB of gain. Providing three amplifier stages having equal levels of gain of this amount is by way of a non-limiting example in that multiple stages in various combinations of gain can also be provided, as would be well understood to those skilled in the art.

The foregoing discussion discloses and describes merely exemplary embodiments of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. An optical amplifier for amplifying an optical signal, said amplifier comprising:
an optical fiber extending through the amplifier, said fiber including an input end and an output end;
a first amplifier stage positioned in the fiber, said first amplifier stage amplifying the optical signal;
a first variable optical attenuator positioned in the fiber and being responsive to the amplified optical signal from the first amplifier stage, said first variable optical attenuator attenuating the amplified optical signal from the first amplifier stage to provide a flat gain spectrum;
a second amplifier stage positioned in the fiber after the first variable optical attenuator, said second amplifier stage amplifying the attenuated optical signal from the first variable optical attenuator;
a second variable optical attenuator positioned in the fiber after the second amplifier stage and being responsive to the amplified optical signal from the second amplifier stage, said second variable optical attenuation attenuating the amplified signal from the second amplifier stage to provide a flat gain spectrum; and
a third amplifier stage positioned in the fiber after the second variable optical attenuator, said third amplifier stage amplifying the attenuated optical signal from the second variable optical amplifier.

2. The amplifier according to claim 1 further comprising a Raman amplifier positioned in the optical fiber proximate the input end, said Raman amplifier amplifying the optical signal prior to the optical signal being sent to the first amplifier stage.

3. The amplifier according to claim 1 wherein the first and second variable optical attenuators operate in the range of 0 to 15 dB.

4. The amplifier according to claim 1 wherein the first and second amplifier stages are pre-amplifier stages having a relatively low noise figure and high gain, and the third amplifier stage is a power amplifier stage having a relatively high noise figure and high efficiency.

5. The amplifier according to claim 1 wherein the amplifier is an erbium doped fiber amplifier and the optical fiber is an erbium doped fiber.

6. The amplifier according to claim 1 further comprising a dispersion compensating module positioned in the fiber between the first and second amplifier stages.

7. The amplifier according to claim 1 further comprising a gain flattening filter positioned in the optical fiber between the second amplifier stage and the third amplifier stage.

8. An erbium doped fiber amplifier for amplifying an optical signal, said amplifier comprising:
an erbium doped optical fiber extending through the amplifier, said fiber including an input end and an output end;
a first pre-amplifier stage positioned in the fiber proximate the input end, said first pre-amplifier stage amplifying the optical signal;
a primary variable optical attenuator positioned in the fiber and being responsive to the amplified optical signal from the first pre-amplifier stage, said primary variable optical attenuator attenuating the amplified optical signal from the first pre-amplifier stage to provide a flat gain spectrum;
a second pre-amplifier stage positioned in the fiber after the primary variable optical attenuator, said second pre-amplifier stage amplifying the attenuated optical signal from the primary variable optical attenuator;
a second variable optical attenuator positioned in the fiber after the second pre-amplifier stage and being responsive to the amplified optical signal from the second amplifier stage, said secondary variable optical attenuator attenuating the amplified signal from the second pre-amplifier stage to provide a flat gain spectrum; and
a power amplifier stage positioned in the fiber after the secondary variable optical attenuator proximate the output end of the fiber cable, said power amplifier stage amplifying the attenuated optical signal from the secondary variable optical amplifier.

9. The amplifier according to claim 8 further comprising a Raman amplifier positioned in the optical fiber proximate the input end, said Raman amplifier amplifying the optical signal prior to the optical signal being sent to the first pre-amplifier stage.

10. The amplifier according to claim 8 wherein the primary and secondary variable optical attenuators operate in the range of 0 to 15 dB.

11. The amplifier according to claim 8 wherein the first and second preamplifier stages have a relatively low noise figure and high gain, and the power amplifier stage has a relatively high noise figure and high efficiency.

12. The amplifier according to claim 8 further comprising a dispersion compensating module positioned in the fiber between the first pre-amplifier stage and the second pre-amplifier stage.

13. The amplifier according to claim 8 further comprising a gain flattening filter positioned in the optical fiber between the second pre-amplifier stage and the power amplifier stage.

14. A method of amplifying an optical signal, said method comprising:
propagating the optical signal through a first amplifier stage for amplifying the optical signal;
propagating the signal through a first variable optical attenuator for attenuating the amplified optical signal from the first amplifier stage to provide a flat gain spectrum;
propagating the attenuated optical signal through a second amplifier stage for amplifying the attenuated optical signal from the first variable optical attenuator;
propagating the optical signal through a second variable optical attenuator for attenuating the amplified optical signal from the second amplifier to provide a flat gain spectrum; and
propagating the attenuated optical signal through a third amplifier stage for amplifying the attenuated optical signal from the second variable optical attenuator.

15. The method according to claim 14 further comprising amplifying the optical signal with a Raman amplifier prior to the optical signal being amplified by the first amplifier stage.

16. The method according to claim 14 wherein propagating the signal through a first amplifier stage includes propagating the signal through a first pre-amplifier stage having a relatively low noise figure and high gain, and propagating the optical signal through a second amplifier stage includes propagating the signal through a second pre-amplifier stage having a relatively low noise figure and high gain, and propagating the optical signal through a third amplifier stage includes propagating the signal through a power amplifier stage having a relatively high noise figure and high efficiency.

17. The method according to claim 14 wherein the optical signal is amplified by an erbium doped amplifier having an erbium doped fiber.

18. The method according to claim 14 further comprising propagating the signal through a dispersion compensating module after the signal is propagated through the first amplifier stage, but before the signal is propagated through the second amplifier stage.

19. The method according to claim 14 further comprising propagating the signal through a gain flattening filter after the signal is propagated through the second amplifier stage, but before the signal is propagated through the third amplifier stage.
